(19) United States
(12) Patent Application Publication
(10) Pub. No.: US 2025/0216814 A1
(43) Pub. Date: Jul. 3, 2025

(54) Holographic Light Curtains

(71) Applicant: Carnegie Mellon University, Pittsburgh, PA (US)

(72) Inventors: Dorian Yao Chan, Pittsburgh, PA (US); Matthew O'Toole, Pittsburgh, PA (US); Srinivasa Narasimhan, Pittsburgh, PA (US)

(21) Appl. No.: 18/851,720

(22) PCT Filed: May 26, 2023
(86) PCT No.: PCT/US2023/023679

§ 371 Date: Sep. 27, 2024

Related U.S. Application Data
(60) Provisional application No. 63/324,163, filed on Mar. 28, 2022.

(51) Int. Cl. G03H 1/00; G03H 1/02

(52) U.S. Cl. CPC G03H 1/0005; G03H 1/02; G03H 2001/0044; G03H 2001/0224; G03H 2223/24; G03H 2240/21

(57) ABSTRACT

Provided is a system and method for holographic light curtains. A system includes a holographic projector configured to project a holographic image, a rolling-shutter camera arranged to receive light from the holographic image, and at least one processor in communication with the rolling-shutter camera, the at least one processor programmed or configured to: determine an intensity of the light received from the holographic image; and detect a disturbance in a space of the holographic image based on a change in the intensity.

### CROSS REFERENCE TO RELATED APPLICATION

This application claims the benefit of U.S. Provisional Patent Application No. 63/324,163, filed on Mar. 28, 2022, the disclosure of which is hereby incorporated by reference in its entirety.

### GOVERNMENT LICENSE RIGHTS

This invention was made with Government support under NSF U.S. Pat. No. 1,900,821 awarded by the National Science Foundation. The Government has certain rights in the invention.

### BACKGROUND OF THE INVENTION

### 1. Field

This disclosure relates generally to holography and, in non-limiting embodiments, to holographic light curtains for detecting a disturbance or movement in a space.

### 2. Technical Considerations

A light curtain is an optical barrier that detects the presence or absence of objects within regions of 3D space. Light curtain systems are designed for detecting the presence of objects within a user-defined 3D region of space, which has many applications across vision and robotics. However, the shape of light curtains are limited to ruled surfaces, i.e., surfaces composed of straight lines.

For example, light curtains are used in elevators and garage doors in order to keep doors open when a person or object is in the doorway. Safety light curtains also are used in environments containing hazardous equipment (e.g., machine tools, robotic arms) to protect personnel from injury by automatically turning off dangerous machinery whenever a curtain is breached. These light curtains involve two components: emitters and receivers. These light curtains position an emitter to directly illuminate a receiver through direct line of sight. These light curtains must be physically configured for their specific environments, which is a laborious process.

Some light curtains have been proposed that use triangulation. In these examples, a scene is illuminated with a laser line, and the response is measured with a camera. The intersection of the illumination and sensing planes produces a 3D line and, if an object touches this line, light from the source reflects off of the object and reaches the camera. Rapidly changing the position of the illumination and sensing planes (e.g., with mirror galvanometers) creates ruled surfaces, i.e., surfaces defined by unions of straight lines. Triangulation light curtains have been restricted to being ruled surfaces. Moreover, prior systems offer only one degree of freedom over the positions of the laser line and scan line, limiting triangulation light curtains to an even smaller subset of ruled surfaces.

### SUMMARY

According to non-limiting embodiments or aspects, provided is a system comprising: a holographic projector configured to project a holographic image; a rolling-shutter camera arranged to receive light from the holographic image; and at least one processor in communication with the rolling-shutter camera, the at least one processor programmed or configured to: determine an intensity of the light received from the holographic image; and detect a disturbance in a space of the holographic image based on a change in the intensity.

In non-limiting embodiments or aspects, the holographic projector comprises: a laser light source; a spatial light modulator arranged to receive light from the laser light source; a first lens arranged between the laser light source and the spatial light modulator; and a second lens arranged between the spatial light modulator and an image plane formed by a reflection of the spatial light modulator. In non-limiting embodiments or aspects, the system further comprises: an objective lens arranged between the image plane and a scene of the holographic image; and an optical aperture device arranged between the second lens and the objective lens, the optical aperture device configured to block a portion of the reflection of the spatial light modulator. In non-limiting embodiments or aspects, the at least one processor is further programmed or configured to generate the holographic image by: (a) generating a random pattern for display on the spatial light modulator; (b) propagating a wavefront based on the random pattern from a plane associated with the spatial light modulator to the image plane; (c) replacing an amplitude of the wavefront with a value derived from a target image to generate a new wavefront; (d) propagating the new wavefront from the image plane to the plane associated with the spatial light modulator; (e) binarizing the new wavefront; and (f) repeating steps (b)-(e) until substantially converging to the target image.

In non-limiting embodiments or aspects, the holographic image comprises a plurality of light curtains, and detecting the disturbance in the space of the holographic image comprises detecting separate disturbances in at least one light curtain of the plurality of light curtains. In non-limiting embodiments or aspects, the holographic image comprises a first light curtain and a second light curtain at least partially overlapping the first light curtain, and the first light curtain has a depth or thickness greater than a depth or thickness of the second light curtain. In non-limiting embodiments or aspects, detecting the disturbance in the space of the holographic image is based on an intensity of the first light curtain and an intensity of the second light curtain.

According to non-limiting embodiments or aspects, provided is a system comprising: a laser light source; a spatial light modulator arranged to receive light from the laser light source and reflect at least a portion of the light; an objective lens arranged to project a holographic image based on the at least a portion of the light reflected by the spatial light modulator; a rolling-shutter camera arranged to capture light from the holographic image; and at least one processor configured to detect movement in a space of the holographic image based on data received from the rolling-shutter camera.

In non-limiting embodiments or aspects, the system further comprises: a first lens arranged between the laser light source and the spatial light modulator; a second lens arranged between the spatial light modulator and the objective lens, the objective lens is arranged between an image plane of the second lens and a scene of the holographic image; and an optical aperture device arranged between the second lens and the objective lens, the optical aperture device configured to block a portion of the reflection of the spatial light modulator. In non-limiting embodiments or aspects, the at least one processor is further programmed or configured to generate the holographic image by: (a) generating a random pattern for display on the spatial light modulator; (b) propagating a wavefront based on the random pattern from a plane associated with the spatial light modulator to the image plane; (c) replacing an amplitude of the wavefront with a square root of a target image to generate a new wavefront; (d) propagating the new wavefront from the image plane to the plane associated with the spatial light modulator; (e) binarizing the new wavefront; and (f) repeating steps (b)-(e) until substantially converging to the target image.

In non-limiting embodiments or aspects, the holographic image comprises a plurality of light curtains, and detecting the movement in the space of the holographic image comprises detecting separate disturbances in at least a subset of light curtains of the plurality of light curtains. In non-limiting embodiments or aspects, the holographic image comprises a first light curtain and a second light curtain, the first light curtain and the second light curtain overlapping at least partially, and the first light curtain has a depth or thickness greater than a depth or thickness of the second light curtain. In non-limiting embodiments or aspects, wherein detecting the movement in the space of the holographic image is based on an intensity of the first light curtain and an intensity of the second light curtain.

According to non-limiting embodiments or aspects, provided is a method comprising: generating, with at least one processor, a holographic image; projecting the holographic image to a scene with a holographic projector; capturing at least a portion of the scene with a rolling-shutter camera; and detecting, with at least one processor, a disturbance in a space of the holographic image based on at least one frame received from the rolling-shutter camera.

In non-limiting embodiments or aspects, generating the holographic image comprises: (a) generating a random pattern for controlling a micromirror device; (b) propagating a wavefront based on the random pattern from a plane associated with the micromirror device to an image plane of the holographic image; (c) replacing an amplitude of the wavefront with a square root of a target image to generate a new wavefront; (d) propagating the new wavefront from the image plane to the plane associated with the micromirror device; (e) binarizing the new wavefront; and (f) repeating steps (b)-(e) until substantially converging to the target image.

In non-limiting embodiments or aspects, the holographic image comprises a plurality of light curtains, and detecting the disturbance in the space of the holographic image comprises detecting separate disturbances in at least a subset of light curtains of the plurality of light curtains. In non-limiting embodiments or aspects, the holographic image comprises a first light curtain and a second light curtain, the first light curtain and the second light curtain overlapping at least partially, and the first light curtain has a depth or thickness greater than a depth or thickness of the second light curtain. In non-limiting embodiments or aspects, detecting the disturbance in the space of the holographic image is based on an intensity of the first light curtain and an intensity of the second light curtain. In non-limiting embodiments or aspects, the method further comprises: blocking, with an optical aperture device, at least a portion of a reflection of a micromirror device of the holographic projector.

Other non-limiting embodiments or aspects will be set forth in the following numbered clauses:
Clause 1: A system comprising: a holographic projector configured to project a holographic image; a rolling-shutter camera arranged to receive light from the holographic image; and at least one processor in communication with the rolling-shutter camera, the at least one processor programmed or configured to: determine an intensity of the light received from the holographic image; and detect a disturbance in a space of the holographic image based on a change in the intensity.
Clause 2: The system of clause 1, wherein the holographic projector comprises: a laser light source; a spatial light modulator arranged to receive light from the laser light source; a first lens arranged between the laser light source and the spatial light modulator; and a second lens arranged between the spatial light modulator and an image plane formed by a reflection of the spatial light modulator.
Clause 3: The system of clauses 1 or 2, further comprising: an objective lens arranged between the image plane and a scene of the holographic image; and an optical aperture device arranged between the second lens and the objective lens, the optical aperture device configured to block a portion of the reflection of the spatial light modulator.
Clause 4: The system of any of clauses 1-3, wherein the at least one processor is further programmed or configured to generate the holographic image by: (a) generating a random pattern for display on the spatial light modulator; (b) propagating a wavefront based on the random pattern from a plane associated with the spatial light modulator to the image plane; (c) replacing an amplitude of the wavefront with a value derived from a target image to generate a new wavefront; (d) propagating the new wavefront from the image plane to the plane associated with the spatial light modulator; (e) binarizing the new wavefront; and (f) repeating steps (b)-(e) until substantially converging to the target image.
Clause 5: The system of any of clauses 1-4, wherein the holographic image comprises a plurality of light curtains, and wherein detecting the disturbance in the space of the holographic image comprises detecting separate disturbances in at least one light curtain of the plurality of light curtains.
Clause 6: The system of any of clauses 1-5, wherein the holographic image comprises a first light curtain and a second light curtain at least partially overlapping the first light curtain, and wherein the first light curtain has a depth or thickness greater than a depth or thickness of the second light curtain.
Clause 7: The system of any of clauses 1-6, wherein detecting the disturbance in the space of the holographic image is based on an intensity of the first light curtain and an intensity of the second light curtain.
Clause 8: A system comprising: a laser light source; a spatial light modulator arranged to receive light from the laser light source and reflect at least a portion of the light; an objective lens arranged to project a holographic image based on the at least a portion of the light reflected by the spatial light modulator; a rolling-shutter camera arranged to capture light from the holographic image; and at least one processor configured to detect movement in a space of the holographic image based on data received from the rolling-shutter camera.
Clause 9: The system of clause 8, further comprising: a first lens arranged between the laser light source and the spatial light modulator; a second lens arranged between the spatial light modulator and the objective lens, wherein the objective lens is arranged between an image plane of the second lens and a scene of the holographic image; and an optical aperture device arranged between the second lens and the objective lens, the optical aperture device configured to block a portion of the reflection of the spatial light modulator.
Clause 10: The system of clauses 8 or 9, wherein the at least one processor is further programmed or configured to generate the holographic image by: (a) generating a random pattern for display on the spatial light modulator; (b) propagating a wavefront based on the random pattern from a plane associated with the spatial light modulator to the image plane; (c) replacing an amplitude of the wavefront with a square root of a target image to generate a new wavefront; (d) propagating the new wavefront from the image plane to the plane associated with the spatial light modulator; (e) binarizing the new wavefront; and (f) repeating steps (b)-(e) until substantially converging to the target image.
Clause 11: The system of any of clauses 8-10, wherein the holographic image comprises a plurality of light curtains, and wherein detecting the movement in the space of the holographic image comprises detecting separate disturbances in at least a subset of light curtains of the plurality of light curtains.
Clause 12: The system of any of clauses 8-11, wherein the holographic image comprises a first light curtain and a second light curtain, the first light curtain and the second light curtain overlapping at least partially, and wherein the first light curtain has a depth or thickness greater than a depth or thickness of the second light curtain.
Clause 13: The system of any of clauses 8-12, wherein detecting the movement in the space of the holographic image is based on an intensity of the first light curtain and an intensity of the second light curtain.
Clause 14: A method comprising: generating, with at least one processor, a holographic image; projecting the holographic image to a scene with a holographic projector; capturing at least a portion of the scene with a rolling-shutter camera; and detecting, with at least one processor, a disturbance in a space of the holographic image based on at least one frame received from the rolling-shutter camera.
Clause 15: The method of clause 14, wherein generating the holographic image comprises: (a) generating a random pattern for controlling a micromirror device; (b) propagating a wavefront based on the random pattern from a plane associated with the micromirror device to an image plane of the holographic image; (c) replacing an amplitude of the wavefront with a square root of a target image to generate a new wavefront; (d) propagating the new wavefront from the image plane to the plane associated with the micromirror device; (e) binarizing the new wavefront; and (f) repeating steps (b)-(e) until substantially converging to the target image.
Clause 16: The method of clauses 14 or 15, wherein the holographic image comprises a plurality of light curtains, and wherein detecting the disturbance in the space of the holographic image comprises detecting separate disturbances in at least a subset of light curtains of the plurality of light curtains.
Clause 17: The method of any of clauses 14-16, wherein the holographic image comprises a first light curtain and a second light curtain, the first light curtain and the second light curtain overlapping at least partially, and wherein the first light curtain has a depth or thickness greater than a depth or thickness of the second light curtain.
Clause 18: The method of any of clauses 14-17, wherein detecting the disturbance in the space of the holographic image is based on an intensity of the first light curtain and an intensity of the second light curtain.
Clause 19: The method of any of clauses 14-18, further comprising blocking, with an optical aperture device, at least a portion of a reflection of a micromirror device of the holographic projector.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic diagram of a system for holographic light curtains according to non-limiting embodiments;

FIG. 2 is another schematic diagram of a system for holographic light curtains according to non-limiting embodiments;

FIG. 3 is a flow diagram of a method for implementing holographic light curtains according to non-limiting embodiments;

FIG. 4 is a schematic and flow diagram of a method for generating holographic images for use in a holographic light curtain according to non-limiting embodiments;

FIGS. 5A and 5B illustrate an example implementation of a system for holographic light curtains according to non-limiting embodiments; and

FIG. 6 illustrates example components of a computing device used in connection with non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the subject matter of the disclosure may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a processor, such as a CPU or GPU, a mobile device, and/or other like devices. A computing device may also be a desktop computer or other form of non-mobile computer. Reference to “a processor,” as used herein, may refer to a previously-recited processor that is recited as performing a previous step or function, a different processor, and/or a combination of processors. For example, as used in the specification and the claims, a first processor that is recited as performing a first step or function may refer to the same or different processor recited as performing a second step or function.

As used herein, the term “light curtain” refers to a sensing arrangement in which light is transmitted and the interruption and/or disruption of the transmitted light is used to detect movement. A light curtain may be used for safety in industrial applications, such that the detection of movement automatically turns off dangerous machinery or takes other corrective action. A light curtain may also be used for any other application or scenario in which movement is detected.

Non-limiting embodiments described herein provide for a new and innovative system and method for implementing one or more light curtains to detect a disturbance in a space using one or more holographic images.

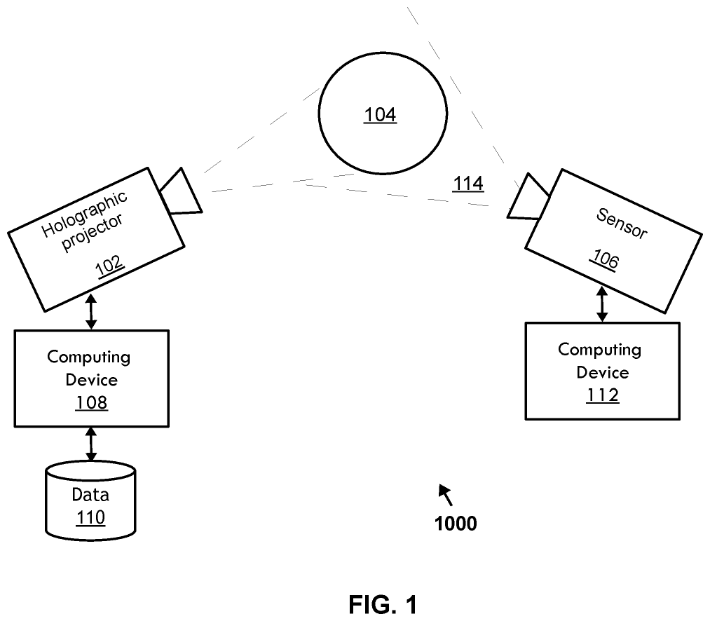

FIG. 1 shows a system 1000 for holographic light curtains according to non-limiting embodiments. A holographic projector 102 is in communication with a computing device 108. The computing device 108 may control the holographic projector to project one or more holographic images 104 into a scene (e.g., area). The computing device 108 may be in communication with a data storage device 110 including image data. The image data may include one or more hologram images, patterns, bitmap images, and/or other like data used to generate and project a hologram image. In some examples, the computing device 108 and/or data storage device 110 may be local to the holographic projector 102. In other examples, the computing device 108 and/or data storage device 110 may be remote from the holographic projector 102 and communicate with the holographic projector 102 through one or more networks.

With continued reference to FIG. 1, the system 1000 for holographic light curtains includes a sensor 106 arranged to capture at least a portion of the scene and the holographic image 104 projected by the holographic projector 102. The sensor 106 may be a rolling shutter camera that captures images by scanning a scene (e.g., within a field-of-view 114 of the sensor). The sensor 106 may scan from top to bottom or from side to side using a rolling shutter mechanism, thereby capturing different parts of the image at different times. The sensor 106 may be in communication with a computing device 112, which may be the same computing device as computing device 108 or a separate computing device. The computing device 112 may receive image data from the sensor 106 for processing. In some examples, the computing device 112 may be local to the sensor 106. In other examples, the computing device 112 may be remote from the sensor 106 and communicate with the sensor 106 through one or more networks.

Still referring to FIG. 1, in operation, the sensor 106 scans the scene, including the holographic image 104, and the computing device 112 determines if the intensity of the light received from the scene changes (e.g., decreases). In response to determining a decrease in light intensity, the computing device automatically detects a disturbance. The disturbance may indicate a movement in a space of the holographic image 104 (e.g., within the physical spatial coordinates of the hologram), such as a person or object. Based on detecting the disturbance, the computing device 112 may record the event in a data storage device 110, may generate and communicate an alert to another device (not shown in FIG. 1), and/or may perform any other action automatically.

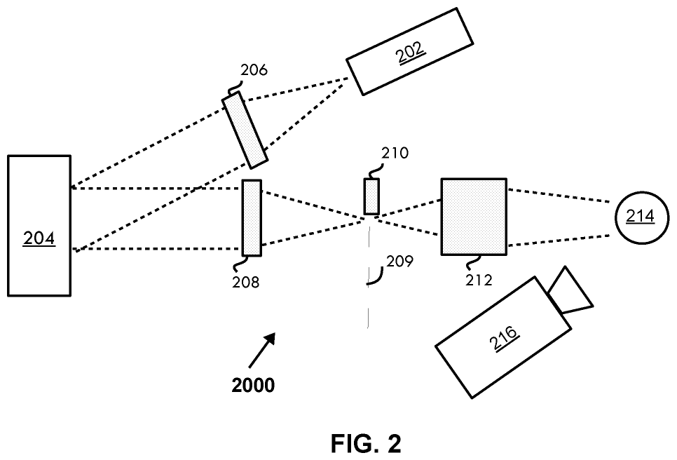

Referring now to FIG. 2, a system 2000 for holographic light curtains is shown according to non-limiting embodiments. A light source 202 is directed to a spatial light modulator 204, such as a digital micromirror device (DMD). A first lens 206 is arranged in an optical path between the light source 202 and the spatial light modulator 204. The first lens 206 may be, for example, a 75 mm achromatic doublet lens (Thorlabs AC254-075-A-ML), although it will be appreciated that various other types of lenses may be used to collimate the light. The spatial light modulator 204 is configured to reflect the light in different patterns along a different optic path. A second lens 208 is arranged in an optic path of the light reflected by the spatial light modulator 204, forming a holographic image at an image plane 209 having an interference pattern from the converged light resulting from the second lens 208. In non-limiting embodiments the second lens 208 may be a 105 mm DSLR lens (Nikon AF Micro-Nikkor) focused at infinity, although it will be appreciated that various other types of lenses may be used. An optical device 210, such as a knife edge aperture, is positioned at the image plane 209 to manipulate the light pattern (e.g., by blocking a portion of the light). For example, the holographic image appearing at the image plane 209 may be conjugate-symmetric, and the knife edge aperture may block half of the image along with the bright direct current (DC) component (e.g., a baseline and/or consistent part of the light pattern).

With continued reference to FIG. 2, an objective lens 212 is arranged in the optic path including the image plane 209, resulting in a holographic image 214 being projected. In non-limiting embodiments the objective lens 212 may be a 9 mm lens (Fujinon HF9HA), although it will be appreciated that various other types of lenses may be used. The light source 202, spatial light modulator 204, first lens 206, second lens 208, optical device 210, and objective lens 212 may be collectively referred to as a holographic projector. The system 2000 also includes a sensor 216, such as a rolling shutter camera, positioned with a field-of-view including at least a portion of the holographic image 214 and/or a scene including light from the holographic image 214. One or more computing devices (not shown in FIG. 2) may be in communication with the holographic projector and sensor 216. In non-limiting embodiments, the sensor 216 may be a UI-3240CPNIR camera, fitted with an 8 mm lens and operated in 2× binning mode for an image resolution of 640×512. A 531 nm bandpass filter with a 10 nm full width at half maximum (FWHM) to reject ambient light may also be used. It will be appreciated that various sensor arrangements may be used.

In the example shown in FIG. 2, various different components may be used to form the holographic projector. The light source 202 may include, for example, a 530 nm fiber-pigtailed laser (e.g., such as a Coherent Sapphire LPX 530-300 Laser, which emits 530 nm light anywhere from 10 mW to 330 mW), although various size and types of lasers may also be used. The first lens 206 may collimate the light from the light source 202 before it is reflected by the spatial light modulator 204. Further, the spatial light modulator 204 in some examples may be a digital micromirror device positioned at an angle (e.g., 24 degrees) with respect to the light from the light source 202. The digital micromirror device may include an array of mirrors having tilt angle states to provide binary amplitude modulation of the wavefront of the light being reflected. Each mirror may have a binary (e.g., “1” or “0”) position. Since a Fourier transform of a binary pattern is conjugate symmetric and typically has a strong DC component (based on the number of pixels turned on in the binary pattern), the optic device 210 blocks the DC component and the symmetric copy of the holographic image, and the objective lens 212 projects the remainder of the image as the resulting holographic image in the scene. The objective lens 212 scales the projected pattern to match the field-of-view of the sensor 216.

The spatial light modulator 204 may be positioned at the Fourier plane (e.g., at a front focal plane of lens 208) to form an interference pattern at the image plane 209 (e.g., at a back focal plane of lens 208). The image formation model for the wavefront U(s,t) at the image plane 209 can be expressed as follows:

$$U ( s , t ) = ℱ \{ u ( x , y ) \cdot a ( x , y ) \} ( s , t ) , \qquad ( 1 )$$

In the above Equation (1), u(x, y) is the pattern displayed on the spatial light modulator, a(x, y) represents optical aberrations associated with imperfections with the spatial light modulator, and F{·} is the Fourier transform operator that models wavefront propagation from the Fourier plane to the image plane. The intensity of a wavefront, which is the signal measured by a camera, is given by its squared magnitude (e.g., |U(s, t)|²).

A holographic projector reallocates light from dark regions toward light parts of the image. The intensity of the line is inversely proportional to the thickness of the line. In some non-limiting embodiments, a fast phase-only spatial light modulator may be used instead of a digital micromirror device to avoid wasting light from the pixels of the micromirror device that are off and the blocked light.

In non-limiting embodiments, an improved, modified Gerchberg-Saxton (GS) algorithm is used to compute a pattern u(x, y) that produces a target image I(s, t)=|U(s, t)|². The modified algorithm alternates between enforcing a constraint on the hologram's intensity at the image plane 209, and enforcing the binary constraint on the pattern at the Fourier plane (e.g., at the spatial light modulator 204). After initializing the pattern u(x, y) with random binary values, the algorithm iteratively performs four operations to compute the hologram. It will be appreciated that fewer, different, and/or more operations may be performed to compute the hologram. First, Equation (1) is used to simulate the propagation of the wavefront from the Fourier plane to the image plane 209. This involves performing an element-wise multiplication with a pre-computed phase pattern a(x, y) and computing the Fourier transform of the result, producing a conjugate symmetric wavefront U(s, t). Next, the phase U(s, t) of this wavefront is maintained, but its amplitude is changed (e.g., replaced) to match the target intensity image. Next, the propagation operator is inverted by using an inverse Fourier transform and performing an element-wise multiplication with the complex conjugate of the phase pattern a(x, y). As a final step, the result may be binarized by setting all values with positive real components to 1 and setting all other values to 0. These steps are repeated until the resulting image converges to the target image.

In non-limiting embodiments, the spatial light modulator 204 may be calibrated. The light reflecting off of the spatial light modulator 204 may be affected by aberrations. The most severe aberrations may be attributed to the non-planarity of the surface of the spatial light modulator 204 (e.g., digital micromirror device), which may be characterized by a spatially-varying phase pattern a(x, y). Ignoring these aberrations results in blurry holographic images. In non-limiting embodiments, the phase aberration image a(x, y) may be pre-computed and the modified GS algorithm is applied to produce sharper holographic images. To calibrate for this distortion, in non-limiting embodiments, a calibration is performed that does not rely on interfering pairs of digital micromirror device blocks like other methods. First, a block of pixels is displayed on the digital micromirror device, where pixels within this block are randomly turned on or off. This forms a random interference pattern, which is imaged with a sensor (e.g., rolling-shutter camera). Next, this block is slid to different digital micromirror device regions and the corresponding interference patterns are recorded (e.g., stored in memory). If the phase pattern varies linearly across a block, this shifts the observed interference pattern. The shifts may be measured by performing zero-normalized cross-correlation between every measurement and a reference interference pattern, and the corresponding gradients on the phase pattern may then be computed. After discretely sampling the gradients at a number of positions on the digital micromirror device, the result is interpolated to densely represent the gradient of the phase across the entire digital micromirror device. Finally, a large linear system is solved to compute the spatially-varying phase values from these phase gradients, which is based on solving a Poisson equation. This calibration method is less computationally complex than prior methods that involve dividing the micromirror device into blocks of pixels and turning on pairs of blocks at the same time to produce interference patterns.

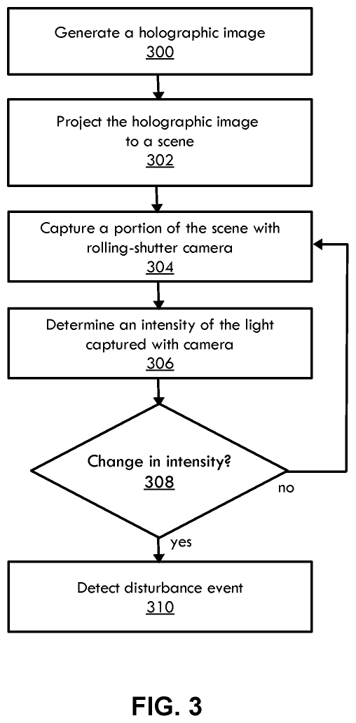

Referring now to FIG. 3, a method for holographic light curtains is shown according to non-limiting embodiments or aspects. It will be appreciated that the order of the steps shown in FIG. 3 is for illustrative purposes only and that non-limiting embodiments may involve more steps, fewer steps, different steps, and/or a different order of steps. In non-limiting embodiments or aspects, each step and/or one or more steps in FIG. 3 may be performed automatically in response to the completion of a previous step. At a first step 300, a holographic image (e.g., a hologram) is generated by a computing device. A modified GS algorithm may be used to generate the holographic image as described herein. At step 302, the holographic image is projected to a scene. For example, a holographic projector may be arranged to project a holographic image to a location within a field-of-view of a sensor (e.g., such as a camera).

With continued reference to FIG. 3, at step 304 at least a portion of the scene (including light from the holographic image) is captured with a sensor, such as a rolling-shutter camera. This may be done by simultaneously exposing an entire row (or column) of pixels to produce a planar viewing frustum, or sensing plane. The intersection between this plane and the virtual surface formed by the light curtain may then be computed. Finally, the holographic projector may then selectively illuminate the intersected regions and this process may be repeated for every row of pixels on the sensor.

The image data from the camera is analyzed and, at step 306, a computing device determines an intensity of the light captured with the camera. At step 308, the computing device determines if the intensity determined at step 306 changes (e.g., decreases), which indicates a disturbance in the space of the holographic image (e.g., an object or entity intersecting with the hologram). The change in intensity at step 308 may be based on satisfying one or more thresholds, such that a decrease in intensity that is equal to and/or greater than a threshold amount triggers a change in intensity at step 308. In response to a change in intensity at step 308, a disturbance event may be detected at step 310. A disturbance event may result in an automatic notification, alert, and/or performance of any other action (e.g., stopping a machine, locking or unlocking a mechanism, and/or the like).

In non-limiting embodiments, a disturbance map may be extracted from the captured images by first imaging a light curtain when the scene is undisturbed and subtracting the light curtain output after the detected disturbance. This results in a difference image over a specific geometry of interest.

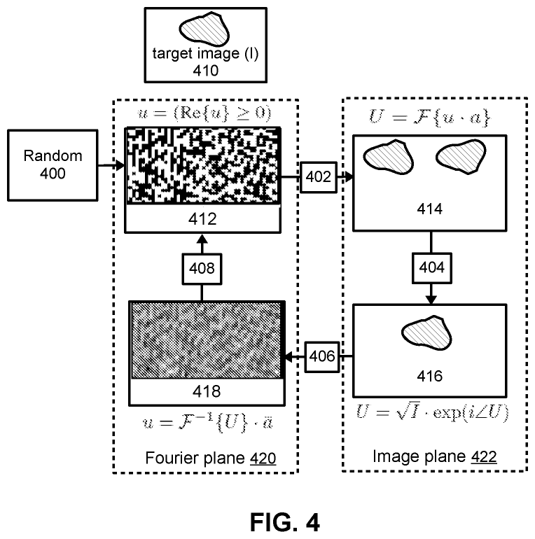

Referring now to FIG. 4, a schematic and flow diagram is shown for executing a modified GS algorithm according to non-limiting embodiments. Given a target image I 410 and a complex-valued phase aberration image a, the modified GS algorithm seeks to find a binary pattern that can be displayed on the digital micromirror device to reproduce the target image. At a first step 400, a random binary pattern 412 is generated for the dimensions of the digital micromirror device. At a next step 402, a wavefront 414 of the binary pattern is propagated from a Fourier plane 420 to an image plane 422. This propagation may be simulated with Equation 1 using an element-wise multiplication with pre-computed phase pattern a(x, y). At a next step 404, an amplitude constraint is applied to replace the amplitude of the wavefront with √I (e.g., the square root value of the target image I) while maintaining the phase of the wavefront. This results in a modified wavefront 416. At a next step 406, the modified wavefront 416 is propagated from the image plane 422 to the Fourier plane 420 which results in a non-binary pattern 418. At a next step 408, a binary constraint is applied to the modified wavefront (non-binary pattern 418) at the Fourier plane 420 to binarize the output and to result in a new binary pattern 412 that replaces the randomly generated pattern and the process of steps 402, 404, 406, and 408 may be iteratively repeated until the resulting binary image converges to the target image I. The modified GS algorithm accounts for large phase aberrations caused by the digital micromirror device, thereby producing sharper target image reconstructions.

Non-limiting embodiments allow for 3D light curtains that provide advantages over 2D horizontal or vertical curtains. Non-limiting embodiments may be used in various implementations and for various purposes. For example, the system can be mounted in an assembly line to inspect whether objects passing through have defects (e.g., by the defects causing a disturbance outside of the expected shape and/or size). In other examples, a 3D touch interface may be implemented using non-limiting embodiments of the holographic light curtains described herein. For example, a light curtain may be formed above (e.g., 2 cm or the like) a desired surface. When a person's finger interacts with this surface, the light curtain detects its location. Non-limiting embodiments may therefore turn any arbitrary geometry into a virtual touch interface. In augmented reality, detecting where a user interacts with a scene may be used as a new input for art or entertainment applications. For example, any real-life object may be turned into a virtual drawing surface.

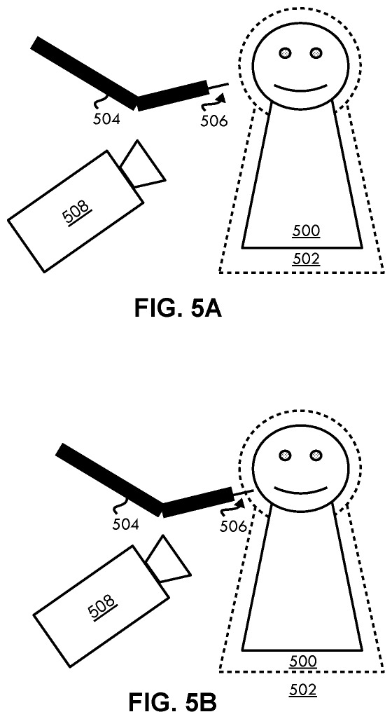

Referring now to FIGS. 5A and 5B, shown is an implementation of a holographic light curtain 502 according to non-limiting embodiments or aspects. An entity 500, such as a person or object, may be at least partially enveloped in the holographic light curtain 502. In this example, a robotic arm 504 supporting an instrument 506 (e.g., a spoon for feeding a medical patient, a surgical instrument for performing a procedure, and/or the like) approaches the entity 500. In the example shown in FIG. 5A, the instrument 506 is outside of the light curtain 502. A sensor 508 is pointed at the light curtain 502 such that a field-of-view of the sensor 508 captures a region adjacent the instrument 506. When the instrument 506 intersects with the light curtain as shown in FIG. 5B, the sensor 508 detects a change in light intensity and can determine that a disturbance has occurred. In the example of an automated feeding robot, the robotic arm 504 may halt in response to the disturbance event such that a spoon or other instrument 506 is at a sufficient distance from the patient's mouth. In other examples, the robotic arm 504 may be halted or reversed during a procedure if the light curtain represents an area of concern that the instrument 506 should not be near. It will be appreciated that various arrangements and use cases are possible.

In non-limiting embodiments, the holographic projector may be light redistributive, which can be verified by projecting lines of different thicknesses onto a flat diffused white surface, and measuring the average brightness of each line using an exposure stack to form a high dynamic range (HDR) image. The pattern brightens as the illuminated area decreases. The optimal light redistribution curve may be plotted by taking the sum of the brightness values of the thinnest line, and normalizing that value by the range of areas.

In non-limiting embodiments, multiple light curtains may be generated and monitored simultaneously. This may be done simultaneously within a single rolling-shutter frame, as an example. In some examples, a first curtain may have a first thickness, and a second curtain may have a larger thickness that overlaps with the first curtain. Thus, if the thick curtain experiences a disturbance while the thinner curtain does not, the disturbance can be determined to be a relatively smaller event. In some examples, multiple light curtains may form layers that can detect an extent of a disturbance based on how many layers experience a disturbance.

In non-limiting embodiments, scalar diffraction theory, including Kirchoff diffraction, can be used to propagate a wavefront from the image plant to any point x in the scene according to the following equation:

$${U}_{scene} ( x ) = {𝒫}_{diffraction} \{ U ( s , t ) \} ( x ) \qquad ( Equation 2 )$$

In non-limiting embodiments, a generalized propagation operator could be used in conjunction with the modified GS algorithm to generate a hologram at a different plane, without needing to physically adjust the objective lens. The hologram may also be optimized for a 2D manifold R in 3D space, e.g., the region of space imaged by a row of camera pixels. If R is planar, this can be done using techniques based on rotating the angular spectrum. However, these propagation operators can be computationally expensive, especially in the context of an iterative GS algorithm which requires evaluating the propagation operator multiple times. Therefore, in non-limiting embodiments a Fourier-based image formation model may be used.

In non-limiting embodiments, to compute the intrinsic and extrinsic parameters of the projector-camera system, a modified projector-camera calibration procedure may be performed in which, in place of a checkerboard pattern, an inverted circleboard pattern (e.g., white circles on a black background) printed onto a planar calibration target is used. Further, the holographic projector may be used to illuminate the calibration target with a sequence of Gray code patterns. Decoding the corresponding Gray code images produces a dense set of correspondences between camera and projector pixels. To minimize the effect of speckle artifacts in the projection patterns, four binary holograms of the same Gray code pattern may be computed, using different initializations of a GS algorithm. The corresponding images may then be captured and averaged to obtain despeckled measurements.

In non-limiting embodiments, accurate time synchronization between the digital micromirror device and rolling-shutter camera is performed. For example, a hardware trigger may start the exposure of the camera when the digital micromirror device displays the first pattern of a sequence. An appropriate pixel clock is then determined for the camera, and an exposure time for the digital micromirror device patterns is also determined. A light emitting diode (LED) blinking at a known, fixed rate may be used to calibrate the inter-row delay of the rolling-shutter camera for different pixel clock values. The camera may be positioned in front of the digital micromirror device, and the digital micromirror device may be illuminated with a bright point light source. The light reflects toward the camera only if the digital micromirror device pixels are turned “on”. The digital micromirror device timings may be calibrated by displaying a sequence of patterns where all the pixels are turned “off”, except for two patterns at known indices where all the pixels are turned “on”. By examining where the bright rows occur in the rolling-shutter capture, the real pattern exposure time of the digital micromirror device and the delay between the start of the digital micromirror device pattern sequence and the start of the rolling-shutter frame for some desired digital micromirror device pattern exposure time can be determined.

In non-limiting embodiments, phase-distortion calibration may be performed if the camera does not exactly image the Fourier transform of the wavefront at the digital micromirror device (e.g., if the sensor just images a subset of the resulting interference pattern or if the interference pattern may be rotated or warped). To account for these issues, a series of Gray codes may be projected to determine correspondences between pixels in the simulated interference pattern and sensor pixels in the real interference pattern. Using these correspondences, a homography may be calculated to warp the captured interference patterns to match the simulated ones. The Gray code measurements may be despeckled by averaging the results of multiple GS algorithm instantiations.

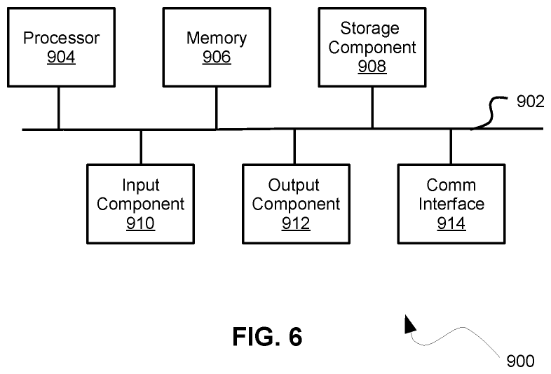

Referring now to FIG. 6, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 6. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 6, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a photo-sensor, a thermal sensor, an electromagnetic field sensor, a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system comprising:
a holographic projector configured to project a holographic image;
a rolling-shutter camera arranged to receive light from the holographic image; and
at least one processor in communication with the rolling-shutter camera, the at least one processor programmed or configured to:
determine an intensity of the light received from the holographic image; and
detect a disturbance in a space of the holographic image based on a change in the intensity.

2. The system of claim 1, wherein the holographic projector comprises:
a laser light source;
a spatial light modulator arranged to receive light from the laser light source;
a first lens arranged between the laser light source and the spatial light modulator; and
a second lens arranged between the spatial light modulator and an image plane formed by a reflection of the spatial light modulator.

3. The system of claim 2, further comprising:
an objective lens arranged between the image plane and a scene of the holographic image; and
an optical aperture device arranged between the second lens and the objective lens, the optical aperture device configured to block a portion of the reflection of the spatial light modulator.

4. The system of claim 2, wherein the at least one processor is further programmed or configured to generate the holographic image by:
(a) generating a random pattern for display on the spatial light modulator;
(b) propagating a wavefront based on the random pattern from a plane associated with the spatial light modulator to the image plane;
(c) replacing an amplitude of the wavefront with a value derived from a target image to generate a new wavefront;
(d) propagating the new wavefront from the image plane to the plane associated with the spatial light modulator;
(e) binarizing the new wavefront; and
(f) repeating steps (b)-(e) until substantially converging to the target image.

5. The system of claim 1, wherein the holographic image comprises a plurality of light curtains, and wherein detecting the disturbance in the space of the holographic image comprises detecting separate disturbances in at least one light curtain of the plurality of light curtains.

6. The system of claim 1, wherein the holographic image comprises a first light curtain and a second light curtain at least partially overlapping the first light curtain, and wherein the first light curtain has a depth or thickness greater than a depth or thickness of the second light curtain.

7. The system of claim 6, wherein detecting the disturbance in the space of the holographic image is based on an intensity of the first light curtain and an intensity of the second light curtain.

8. A system comprising:
a laser light source;
a spatial light modulator arranged to receive light from the laser light source and reflect at least a portion of the light;
an objective lens arranged to project a holographic image based on the at least a portion of the light reflected by the spatial light modulator;
a rolling-shutter camera arranged to capture light from the holographic image; and
at least one processor configured to detect movement in a space of the holographic image based on data received from the rolling-shutter camera.

9. The system of claim 8, further comprising:
a first lens arranged between the laser light source and the spatial light modulator;
a second lens arranged between the spatial light modulator and the objective lens, wherein the objective lens is arranged between an image plane of the second lens and a scene of the holographic image; and
an optical aperture device arranged between the second lens and the objective lens, the optical aperture device configured to block a portion of the reflection of the spatial light modulator.

10. The system of claim 9, wherein the at least one processor is further programmed or configured to generate the holographic image by:
(a) generating a random pattern for display on the spatial light modulator;
(b) propagating a wavefront based on the random pattern from a plane associated with the spatial light modulator to the image plane;
(c) replacing an amplitude of the wavefront with a square root of a target image to generate a new wavefront;
(d) propagating the new wavefront from the image plane to the plane associated with the spatial light modulator;
(e) binarizing the new wavefront; and
(f) repeating steps (b)-(e) until substantially converging to the target image.

11. The system of claim 8, wherein the holographic image comprises a plurality of light curtains, and wherein detecting the movement in the space of the holographic image comprises detecting separate disturbances in at least a subset of light curtains of the plurality of light curtains.

12. The system of claim 8, wherein the holographic image comprises a first light curtain and a second light curtain, the first light curtain and the second light curtain overlapping at least partially, and wherein the first light curtain has a depth or thickness greater than a depth or thickness of the second light curtain.

13. The system of claim 12, wherein detecting the movement in the space of the holographic image is based on an intensity of the first light curtain and an intensity of the second light curtain.

14. A method comprising:
generating, with at least one processor, a holographic image;
projecting the holographic image to a scene with a holographic projector;
capturing at least a portion of the scene with a rolling-shutter camera; and
detecting, with at least one processor, a disturbance in a space of the holographic image based on at least one frame received from the rolling-shutter camera.

15. The method of claim 14, wherein generating the holographic image comprises:
(a) generating a random pattern for controlling a micromirror device;
(b) propagating a wavefront based on the random pattern from a plane associated with the micromirror device to an image plane of the holographic image;
(c) replacing an amplitude of the wavefront with a square root of a target image to generate a new wavefront;
(d) propagating the new wavefront from the image plane to the plane associated with the micromirror device;
(e) binarizing the new wavefront; and
(f) repeating steps (b)-(e) until substantially converging to the target image.

16. The method of claim 14, wherein the holographic image comprises a plurality of light curtains, and wherein detecting the disturbance in the space of the holographic image comprises detecting separate disturbances in at least a subset of light curtains of the plurality of light curtains.

17. The method of claim 14, wherein the holographic image comprises a first light curtain and a second light curtain, the first light curtain and the second light curtain overlapping at least partially, and wherein the first light curtain has a depth or thickness greater than a depth or thickness of the second light curtain.

18. The method of claim 17, wherein detecting the disturbance in the space of the holographic image is based on an intensity of the first light curtain and an intensity of the second light curtain.

19. The method of claim 14, further comprising blocking, with an optical aperture device, at least a portion of a reflection of a micromirror device of the holographic projector.
